(19) United States
(12) Patent Application Publication
(10) Pub. No.: US 2026/0177679 A1
(43) Pub. Date: Jun. 25, 2026

(54) LIDAR AND CONTROL METHOD THEREOF

(71) Applicant: Lunor Technology Co., Ltd., Beijing (CN)

(72) Inventors: Yi LI, Beijing (CN); Junbo FENG, Beijing (CN); Yang XU, Beijing (CN); Yongqiang DENG, Beijing (CN)

(73) Assignee: Lunor Technology Co., Ltd., Beijing (CN)

(21) Appl. No.: 19/432,164

(22) Filed: Dec. 24, 2025

(30) Foreign Application Priority Data
Dec. 25, 2024 (CN) 202411931516.8

(51) Int. Cl. G01S 7/4911; G01S 7/497

(52) U.S. Cl. CPC G01S 7/4911; G01S 7/497

(57) ABSTRACT

The present disclosure relates to the field of laser detection technology, and provides a LiDAR and a control method thereof. The LiDAR includes a light source, a beam splitting structure, a transceiver module and a detection module; the beam splitting structure includes a first coupler, a first phase shifter and a second coupler that are sequentially connected along an optical path. Among them, the first phase shifter is used to alter a phase difference between the first light beam and the second light beam, that enables the second coupler to dynamically adjust the splitting ratio of the detection light and the local oscillator light, effectively reduces an overall loss and improves an efficiency of light energy utilization.

### CROSS-REFERENCE TO RELATED APPLICATION

This application claims the priority benefit of China application serial no. 202411931516.8, filed on Dec. 25, 2024. The entirety of the above-mentioned patent application is hereby incorporated by reference herein and made a part of this specification.

### TECHNICAL FIELD

The present disclosure relates to the field of laser detection technology and, in particular, to a LiDAR and a control method thereof.

### BACKGROUND

Frequency modulated continuous wave (Frequency Modulated Continuous Wave, FMCW) ranging is an important ranging technology of a Light Detection and Ranging (LiDAR). The frequency modulated continuous wave technology requires light to be split into two beams: one beam is local oscillator light, and the other beam is signal light (i.e. detection light). If the LiDAR (e.g. the FMCW LiDAR) employs an on-chip integration scheme, for example, the light splitting is performed on a photonic integrated circuit (PIC) (e.g. an optical chip), a coupler, such as a directional coupler, a Y-branch coupler and a multimode interference (MMI) coupler, is usually used to split the light. The disadvantage of directional couplers is that they require high semiconductor processing technology, have poor performance consistency, and are difficult to adjust the splitting ratio. The disadvantage of both Y-branch coupler and MMI coupler is that it is difficult to make a trade off between the splitting ratio and loss (i.e. it is difficult to achieve both a desired splitting ratio and low loss simultaneously). In the case of a splitting ratio of 1:1, the loss is the lowest. However, this splitting ratio will result in a decrease in the proportion of signal light energy (i.e. detection light energy), which seriously affects the detection capability. Therefore, this splitting ratio is not suitable as a ratio for distributing the local oscillator light and the signal light. If other splitting ratios are used for the Y-branch and MMI couplers, losses will increase. Besides, splitting ratios of Y-branch and MMI couplers cannot be dynamically adjusted.

### SUMMARY

The purpose of the present disclosure is to provide a LiDAR and a control method thereof, aiming to solve the technical problem that existing LiDARs are difficult to make a trade off between the loss and splitting ratio.

In a first aspect, the present disclosure provides a LiDAR, where the LiDAR includes a light source, a beam splitting structure, a transceiver module and a detection module; the light source is configured to provide a laser beam;
the beam splitting structure includes a first coupler, a first phase shifter and a second coupler that are sequentially connected along an optical path; the first coupler is configured to receive the laser beam provided by the light source and split the laser beam into a first light beam and a second light beam; the second coupler is configured to split the received first light beam and the received second light beam into local oscillator light and detection light; the first phase shifter is configured to alter a phase of the first light beam, so as to alter a phase difference between the first light beam and the second light beam, to alter a splitting ratio of the second coupler and form the local oscillator light and the detection light;
the transceiver module is configured to receive the detection light and send the detection light to a detection area, as well as to receive an echo signal within the detection area; where the echo signal is formed by the detection light being reflected by an object in the detection area; the detection module is configured to receive the echo signal and the local oscillator light.

In an embodiment, the beam splitting structure further includes a second phase shifter, the second phase shifter is configured to alter a phase of the second light beam, so as to alter the phase difference between the first light beam and the second light beam, to alter the splitting ratio of the second coupler.

In an embodiment, at least one of the first coupler and the second coupler is any one of an MMI (multimode interference) coupler, a Y-branch coupler or a directional coupler.

In an embodiment, at least one of the first coupler and the second coupler is prepared by using material of silicon nitride, silicon, lithium niobate or silicon carbide.

In an embodiment, the first coupler is a 1*2 coupler, the second coupler is a 2*2 coupler; at least one of the first coupler and the second coupler is a 3 dB coupler.

In an embodiment, the first phase shifter is one of a thermo-optic phase shifter, an electro-optic phase shifter, an acousto-optic phase shifter or an MEMS phase shifter.

In an embodiment, the LiDAR includes an optical chip, the beam splitting structure and the transceiver module are integrated into the optical chip.

In an embodiment, the transceiver module includes an OPA, an optical switch antenna array or an arrayed waveguide grating component.

In an embodiment, a range of a splitting ratio of the detection light to the local oscillator light is from (90:10) to (99:1).

In an embodiment, the splitting ratio of the detection light to the local oscillator light is 99:1.

In an embodiment, the transceiver module is configured to determine detection information of the detection area according to frequency of respective interference signals at a plurality of detection positions in the detection area, and a respective interference signal is generated by beating between an echo signal and local oscillator light at a detection position in the detection area.

In a second aspect, the present disclosure provides a control method of a LiDAR, where the LiDAR includes a light source, a beam splitting structure, a transceiver module and a detection module, the beam splitting structure includes a first coupler, a first phase shifter and a second coupler that are sequentially connected along an optical path, the method includes following steps:
providing, by the light source, a laser beam to the first coupler in the beam splitting structure;
splitting, by the first coupler, the laser beam into a first light beam and a second light beam, providing the first light beam to the first phase shifter, and providing the second light beam to the second coupler;
altering, by the first phase shifter, a phase of the first light beam, and providing the first light beam with an altered phase to the second coupler;
adjusting, by the second coupler, a splitting ratio according to a phase difference between the first light beam with the altered phase and the second light beam, to form detection light and local oscillator light.

The beneficial effects of the LiDAR and the control method thereof provided by the present disclosure are: the light source provides the laser beam; the beam splitting structure splits the laser beam into the detection light and the local oscillator light; the transceiver module receives the detection light and sends the detection light to the detection area, and receives the echo signal reflected back from the detection area; the detection module receives the echo signal and the local oscillator light, and then the echo signal and the local oscillator light beat with each other to generate an interference signal; detection information of the detection area can be determined according to frequency of respective interference signals at a plurality of detection positions in the detection area. Among them, the first phase shifter alters, by altering a phase of the first light beam, a phase difference between the first light beam and the second light beam, that enables the second coupler to dynamically adjust the splitting ratio of the detection light and the local oscillator light, i.e. power distribution, this effectively reduces an overall loss, improves an efficiency of light energy utilization, and solves the technical problem that existing LiDARs are difficult to make a trade off between the loss and the splitting ratio.

### BRIEF DESCRIPTION OF DRAWINGS

In order to illustrate the technical solutions of embodiments of the present disclosure more clearly, the drawings that need to be used in the description of the embodiments or the prior art will be briefly introduced in the following. Obviously, the drawings in the following description are only some embodiments of the present disclosure. For those of ordinary skill in the art, other drawings can be obtained according to these drawings without paying any creative effort.

FIG. 1 is a schematic structure diagram of a LiDAR according to an embodiment of the present disclosure.

FIG. 2 is a schematic operating diagram of a beam splitting structure of a LiDAR according to an embodiment of the present disclosure.

FIG. 3 is another schematic operating diagram of a beam splitting structure of a LiDAR according to an embodiment of the present disclosure.

FIG. 4 is a schematic flowchart of a control method of a LiDAR according to an embodiment of the present disclosure.

### RESPECTIVE REFERENCE SIGNS IN THE DRAWINGS

1: light source; 2: beam splitting structure; 3: transceiver module; 4: detection module; 10: first coupler; 20: first phase shifter; 30: second coupler; 40: second phase shifter.

### DESCRIPTION OF EMBODIMENTS

Embodiments of the present disclosure are described below in detail, examples of the embodiments are shown in the accompanying drawings, where identical or similar reference signs throughout represent identical or similar components or components with identical or similar functions. The embodiments described below with reference to the accompanying drawings are exemplary and intended to explain the present disclosure, but cannot be understood as limitations to the present disclosure.

Referring to “an embodiment” or “embodiments” throughout the entire specification means that specific features, structures, or characteristics described in conjunction with the embodiment(s) are included in at least one embodiment of the present disclosure. Therefore, the phrase “in an embodiment” or “in some embodiments” appears throughout the entire specification, and not all references are to the same embodiment. Furthermore, in one or more embodiments, specific features, structures, or characteristics may be combined in any suitable manner.

In the description of the present disclosure, it should be understood that orientations or position relationships indicated by terms “length”, “width”, “above”, “below”, “front”, “back”, “left”, “right”, “vertical”, “horizontal”, “top”, “bottom”, “inside”, “outside”, etc. are orientations or position relationships based on the orientation or position relationship shown in the drawings, which is only for the convenience of describing the present disclosure and simplifying the description, and does not indicate or imply that an apparatus or an element referred to must have a specific orientation or be constructed and operated in a specific orientation, and therefore, cannot be understood as a limitation to the present disclosure.

In addition, terms “first” and “second” aims only to be used for description and cannot be understood as indicating or implying relative importance or indicating a quantity of technical features implicitly. Therefore, features limited with “first” and “second” can explicitly or implicitly mean including one or more of these features.

In the present disclosure, unless otherwise specified and limited, terms “installation”, “link”, “connection”, “fixation” and other terms should be broadly understood, for example, they can be fixed connections, detachable connections, or integrated; they can be mechanical connections or electrical connections; they can be direct connection or indirect connection through an intermediate medium, they can be an internal connection of two components or an interaction relationship between two components. For those of ordinary skill in the art, specific meanings of the terms described above in the present disclosure can be understood based on specific circumstances.

### First Embodiment

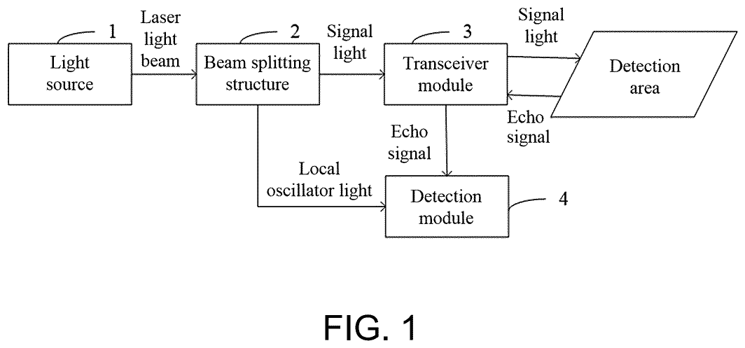

FIG. 1 shows a specific embodiment of a LiDAR according to the present disclosure. A light source 1 provides a laser beam, a beam splitting structure 2 splits the laser beam into signal light and local oscillator light, a transceiver module 3 receives the signal light and sends the signal light to a detection area, and receives an echo signal reflected back from the detection area, a detection module 4 receives the echo signal and the local oscillator light, and then the echo signal and the local oscillator light interfere with each other to generate an interference signal; detection information of the detection area can be determined according to frequency of respective interference signals at a plurality of detection positions in the detection area. The signal light is also known as the detection light herein.

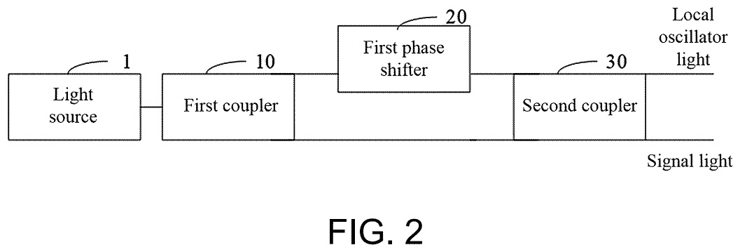

FIG. 2 shows a specific embodiment of the beam splitting structure 2 of the LiDAR. A first phase shifter 20 alters, by altering a phase of a first light beam, a phase difference between the first light beam and a second light beam, that enables a second coupler 30 to dynamically adjust the splitting ratio of the signal light and the local oscillator light, i.e. power distribution, this effectively reduces an overall loss and improves an efficiency of light energy utilization.

It should be noted that, the LiDAR provided by the present disclosure can dynamically adjust the splitting ratio of the signal light and the local oscillator light through the first phase shifter 20, without the need to set an optical circulator. When the echo signal is weak, the phase difference between the first light beam and the second light beam can be altered to increase the splitting ratio, for example, the splitting ratio may be adjusted from 50:50 to 90:10, or even adjusted from 50:50 to 99:1, or even further adjusted from 50:50 to 99.9:0.1 to enhance the signal light intensity, and avoid the echo signal being overwhelmed by the local oscillator light. Additionally, there is no need to attenuate or discard the local oscillator light with a smaller proportion in a later stage, avoiding wasting optical power and improving laser efficiency. In addition, when the injected laser power increases, the problem of saturation of a detector can be prevented by appropriately reducing the proportion of the local oscillator light; and, when the deviation of the splitting ratio from an ideal ratio is large due to the preparation process, the splitting ratio can be adjusted by the first phase shifter to maintain the output power of the local oscillator light the same/similar as the output power of the local oscillator light formed according to the ideal ratio.

In the present disclosure, a first output port of a first coupler 10 is directly connected to a first input port of the second coupler 30 through a first waveguide (not shown), and a second output port of the first coupler 10 is directly connected to a second input port of the second coupler 30 through a second waveguide, without the need to set an intermediate component; In an exemplary embodiment, the first phase shifter is located on the first waveguide. In an exemplary embodiment, a first output port of a first coupler 10 is directly connected to a first input port of the second coupler 30 through the first phase shifter 20.

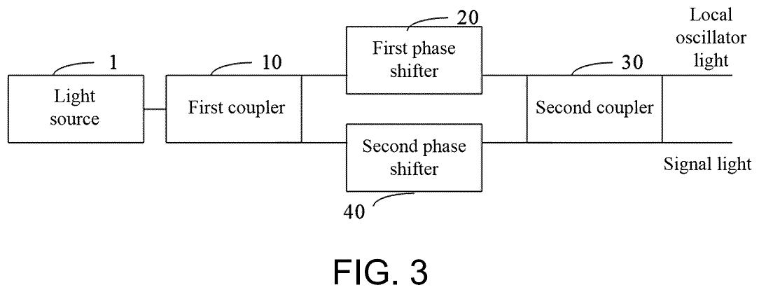

In an exemplary embodiment, the first phase shifter 20 shown in FIG. 2 and FIG. 3 is one of a thermo-optic phase shifter, an electro-optic phase shifter, an acousto-optic phase shifter or an MEMS phase shifter. If the splitting ratio is adjusted by adjusting the first coupler 10 or the second coupler 30, the physical structure or optical characteristics of the coupler need to be changed, which will introduce additional scattering or absorption losses, and cannot achieve dynamic adjustment. However, the beam splitting structure 2 adjusting the phase through the first phase shifter 20 in the embodiments of the present disclosure does not cause additional optical loss or increase additional loss.

The thermo-optic phase shifter changes a refractive index of the material by heating, thereby accurately altering a phase of the first light beam, achieving dynamic changes of the splitting ratio, and its stability assists in maintaining the performance of the LiDAR for a long time. The electro-optic phase shifter utilizes electric field to change the refractive index of the material, thereby achieving rapid phase adjustment, assisting in optimizing the splitting ratio in real time, and improving detection efficiency. The acousto-optic phase shifter alters the refractive index by generating pressure waves in the material through sound waves, thereby achieving non-contact phase adjustment and maintaining stable performance in harsh driving environments. MEMS (micro-electro-mechanical systems) phase shifters utilize tiny mechanical structures to alter the path or refractive index of light beams, thereby achieving phase adjustment, and they have the characteristics of small size, low power consumption, and high integration, which are conducive to the miniaturization and micromation design of the LiDAR.

Specifically, the electro-optic phase shifter is taken as an example of the first phase shifter 20. Assuming that the optical power of the laser beam received by the first coupler 10 is Iᵢₙ, the optical power I₁ of the signal light and the optical power I₂ of the local oscillator light are as follows:

$${I}_{1} = {{I}_{i n} ( sin \frac{Δ θ}{2} )}^{2} ;$$

$${I}_{2} = {{I}_{i n} ( cos \frac{Δ θ}{2} )}^{2} ;$$

among them, Δθ is a phase difference between the local oscillator light and the signal light, Δθ=Δθ₁+Δθ₂+Δθ₃, Δθ₁ is a phase difference between the first light beam and the second light beam introduced by the first coupler 10, Δθ₂ is a phase difference between the first light beam and the second light beam introduced by the first phase shifter 20, Δθ₃ is a phase difference between the first light beam and the second light beam introduced by the second coupler 30, and the sum of the three represents the phase difference between the local oscillator light and the signal light. Thus, the first coupler 10, the first phase shifter 20, and the second coupler 30 form an MZI (Mach-Zehnder Interferometer) structure. In the situation with the absence of additional adjustment measures and in a stable environment, the phase differences introduced by the first coupler 10 and the second coupler 30 are fixed and determined jointly by the design and manufacturing of the couplers. After production, such phase differences will not be easily changed. The value range of the phase difference Δθ₂ introduced by the first phase shifter 20 is [0°, 360°]. Therefore, by adjusting the first phase shifter 20, Δθ can be greatly altered, thereby altering the splitting ratio I₁:I₂ of the signal light and the local oscillator light.

FIG. 3 shows another specific embodiment of the beam splitting structure 2. The beam splitting structure 2 further includes a second phase shifter 40. The second phase shifter 40 is configured to alter a phase of the second light beam, so as to alter the phase difference between the first light beam and the second light beam, to alter the splitting ratio of the second coupler 30. Based on this, in an embodiment, the LiDAR can adjust any one of or both of the first phase shifter 20 and the second phase shifter 40, to more flexibly control a phase difference between the first light beam and the second light beam when they reach the second coupler 30, achieving a wider and more accurate range of the splitting ratio.

In an exemplary embodiment, the second phase shifter 40 shown in FIG. 3 is one of a thermo-optic phase shifter, an electro-optic phase shifter, an acousto-optic phase shifter or an MEMS phase shifter, which is not exclusively limited here.

In an embodiment, a range of an optical power ratio of the signal light to the local oscillator light is 90:10˜99:1. The optical power ratio of the signal light is also known as a splitting ratio of the signal light herein. When ranging with LiDAR, signal light with high-power assists in improving ranging accuracy and depth, while local oscillator light with appropriate power assists in achieving stable signal detection and demodulation. In addition, when a monitoring link is also installed in the LiDAR, the above-mentioned control method further includes: the local oscillator light can be further split into two sub-beams by a beam splitter, one of the beams is used to beat with the detection light, while the other serves as correction light and enters the monitoring link to calibrate the ranging result(s)

Specifically, the optical power ratio of the signal light to the local oscillator light is 99:1, which enables the LiDAR to have good detection capability, and facilitates the beating of the two to form an interference signal.

In some exemplary embodiments, the first coupler 10 in FIG. 2 and FIG. 3 is any one of an MMI coupler, a Y-branch coupler or a directional coupler. These couplers can all achieve a high degree of integration, which assists in reducing volume and weight of the LiDAR. Additionally, the coupler with low loss ensures that signal light emitted by the LiDAR possesses strong detection capability, which improves the detection accuracy and efficiency of the LiDAR, and improves the portability and flexibility of the system.

The splitting and combining of laser beams in MMI couplers is achieved via the self-imaging effect within multimode waveguides. The Y-branch coupler splits the laser beam(s) into two paths through a Y-shaped waveguide structure, maintaining low loss and a stable splitting ratio. The directional coupler utilizes a coupling effect among waveguides to achieve the distribution of the laser beam(s), with high coupling efficiency and flexibility.

In some embodiments, combined with FIG. 2 and FIG. 3, the first coupler 10 is a 1*2 coupler. Input laser beam is completely and effectively distributed to two output ports of the first coupler, forming the first light beam and the second light beam, rather than simply being reflected or absorbed, instead, this fundamentally eliminates light reflection and light absorption, thereby reducing the loss of optical signals and improving the utilization rate of optical signals.

In some embodiments, combined with FIG. 2 and FIG. 3, the first coupler 10 is a 3 dB coupler that can accurately distribute the input optical signal to two output ports of the first coupler in a ratio of 50:50; the 3 dB coupler possesses high isolation, which can assist in reducing system noise and improving signal quality.

In some embodiments, combined with FIG. 2 and FIG. 3, the first coupler 10 is prepared by using material of silicon nitride, silicon, lithium niobate or silicon carbide. Based on this, when the first coupler 10 is integrated on an optical chip, the first coupler 10 has a large refractive index difference between a silicon core and the surrounding cladding (usually silicon dioxide), and the light beam is well confined in the first coupler 10, to reduce losses; and the first coupler 10 is suitable for high-density photonic integrated circuits with small bending radii.

In an exemplary embodiment, the first coupler 10 is a fiber-optic coupler, a micro-optical-element-type coupler, an integrated-optical-waveguide coupler, or other types of couplers, which are not specifically limited here.

In some embodiments, combined with FIG. 2 and FIG. 3, the second coupler 30 is any one of an MMI coupler, a Y-branch coupler or a directional coupler. These couplers can all achieve a high degree of integration, which assists in reducing volume and weight of the LiDAR. The coupler with low loss ensures that signal light emitted by the LiDAR possesses strong detection capability, which improves the detection accuracy and efficiency of the LiDAR, and improves the portability and flexibility of the system.

The splitting and combining of laser beams in MMI couplers is achieved via the self-imaging effect within multimode waveguides. The Y-branch coupler splits the laser beam(s) into the first light beam and the second light beam through a Y-shaped waveguide structure, maintaining low loss and a stable splitting ratio. The directional coupler utilizes a coupling effect among waveguides to achieve the distribution of the laser beam(s), with high coupling efficiency and flexibility.

In some embodiments, combined with FIG. 2 and FIG. 3, the second coupler 30 is prepared by using material of silicon nitride, silicon, lithium niobate or silicon carbide. Based on this, when the second coupler 30 is integrated on an optical chip, the second coupler 30 has a large refractive index difference between a silicon core and the surrounding cladding (usually silicon dioxide), and the light beam is well confined in the second coupler 30, to reduce losses; and the second coupler 30 is suitable for high-density photonic integrated circuits with small bending radii.

In an exemplary embodiment, the second coupler 30 is a fiber-optic coupler, a micro-optical-element-type coupler, an integrated-optical-waveguide coupler, or other types of couplers, which are not specifically limited here.

In some embodiments, combined with FIG. 2 and FIG. 3, the second coupler 30 is a 2*2 coupler that allows bidirectional coupling. The first light beam and the second light beam are effectively distributed to two input ports, and are completely and effectively output as the signal light and the local oscillator light from both output ports, which assists in reducing the loss of the optical signal(s) and improving the utilization of the optical signal(s).

In some embodiments, combined with FIG. 2 and FIG. 3, the second coupler 30 is a 3 dB coupler that can accurately distribute the input optical signal to two output ports in a ratio of 50:50; the 3 dB coupler possesses high isolation, which can assist in reducing system noise and improving signal quality.

In an embodiment, the LiDAR includes the optical chip, the beam splitting structure 2 and the transceiver module 3 are integrated into the same optical chip, greatly reducing assembly difficulty and volume. Among them, the signal light may be transmitted to a silicon optical chip, such as an optical phased array (OPA), an optical switch antenna array or an arrayed waveguide grating (AWG) component, etc.

In an embodiment, the transceiver module 3 includes an OPA, an optical switch antenna array or an arrayed waveguide grating component. The OPA is highly integrated into the optical chip, assisting in reducing volume and weight of the LiDAR, and improving the portability and flexibility of the system. The optical switch antenna array achieve fast switching of multiple beam channels, and flexibly adjust the transmission path and detection area of the light beam(s) by programming the turning on and turning off of the optical switch. The arrayed waveguide grating component can efficiently split the input light beam(s) into multiple beams of different wavelengths, thereby achieving simultaneous detection of different distances or different target objects.

In one embodiment, When transceiver module 3 includes one transmitting OPA and multiple receiving OPAs, the laser beam can be split by multiple cascaded beam splitting structures to obtain one detection light and multiple local oscillator lights; alternatively, the laser beam can first be split into two parts by one such beam splitting structure, with one part used as detection light and the other further split by a beam splitter to get multiple local oscillator lights.

### Second Embodiment

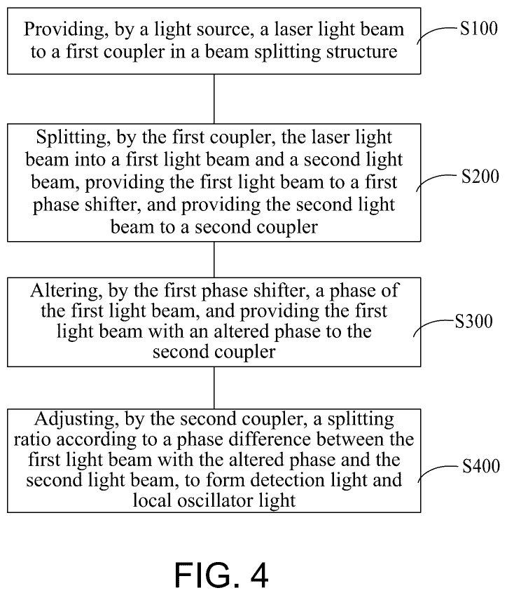

FIG. 4 shows a schematic flowchart of a control method of a LiDAR. The LiDAR may use any of the LiDARs in the first embodiment. The control method shown in FIG. 4 includes following steps.
S100: providing, by a light source 1, a laser beam to a first coupler 10 in a beam splitting structure 2.
S200: splitting, by the first coupler 10, the laser beam into a first light beam and a second light beam, providing the first light beam to a first phase shifter 20, and providing the second light beam to a second coupler 30.
S300: altering, by the first phase shifter 20, a phase of the first light beam, and providing the first light beam with an altered phase to the second coupler 30.
S400: adjusting, by the second coupler 30, a splitting ratio according to a phase difference between the first light beam with the altered phase and the second light beam, to form detection light and local oscillator light. The detection light is also known as the signal light herein.

According to the above-mentioned control method, a phase of the first light beam is altered by the first phase shifter 20, thus a phase difference between the first light beam and the second light beam is altered, that enables the second coupler 30 to dynamically adjust the splitting ratio of the signal light and the local oscillator, i.e. power distribution, this effectively reduces an overall loss and improves an efficiency of light energy utilization. It should be noted that, the LiDAR provided by the present disclosure can dynamically adjust the splitting ratio of the signal light and the local oscillator light through the first phase shifter 20, without the need to set an optical circulator. When the echo signal is weak, the phase difference between the first light beam and the second light beam can be altered to increase the splitting ratio, for example, the splitting ratio may be adjusted from 50:50 to 90:10, or even adjusted from 50:50 to 99:1, or even further adjusted from 50:50 to 99.9:0.1 to enhance the signal light intensity, and avoid the echo signal being overwhelmed by the local oscillator light.

Furthermore, a transceiver module 3 receives the signal light and sends the signal light to a detection area, and receives an echo signal reflected back from the detection area, the detection module 4 receives the echo signal and the local oscillator light, and then the echo signal and the local oscillator light beat with each other to generate an interference signal; detection information of the detection area can be determined according to frequency of respective interference signals at a plurality of detection positions in the detection area. In addition, when a monitoring link is also installed in the LiDAR, the above-mentioned control method further includes: splits the local oscillator light into two sub-beams by a beam splitter, where one of the beams is used to beat with the detection light, while the other serves as correction light and enters the monitoring link to calibrate the ranging result(s).

In an embodiment, the above-mentioned control method further includes: altering, by a second phase shifter 40, a phase of the second light beam, and providing the second light beam with an altered phase to the second coupler 30, so as to alter the phase difference between the first light beam and the second light beam. Based on this, in an embodiment, the LiDAR can adjust any one of or both of the first phase shifter 20 and the second phase shifter 40, to more flexibly control a phase difference between the first light beam and the second light beam when they reach the second coupler 30, achieving a wider and more accurate range of the splitting ratio.

The above descriptions are only exemplary embodiments of the present disclosure and are not intended to limit the present disclosure. Any modifications, equivalent substitutions, and improvements made within the spirit and principles of the present disclosure shall be included in the protection scope of the present disclosure.

What is claimed is:

1. A LiDAR, wherein the LiDAR comprises a light source, a beam splitting structure, a transceiver module and a detection module; the light source is configured to provide a laser beam;
the beam splitting structure comprises a first coupler, a first phase shifter and a second coupler that are sequentially connected along an optical path; the first coupler is configured to receive the laser beam provided by the light source and split the laser beam into a first light beam and a second light beam; the second coupler is configured to split the received first light beam and the received second light beam into local oscillator light and detection light; the first phase shifter is configured to alter a phase of the first light beam, so as to alter a phase difference between the first light beam and the second light beam, to alter a splitting ratio of the second coupler and form the local oscillator light and the detection light;
the transceiver module is configured to receive the detection light and send the detection light to a detection area, as well as to receive an echo signal within the detection area; wherein the echo signal is formed by the detection light being reflected by an object in the detection area, the detection module is configured to receive the echo signal and the local oscillator light.

2. The LiDAR according to claim 1, wherein the beam splitting structure further comprises a second phase shifter, the second phase shifter is configured to alter a phase of the second light beam, so as to alter the phase difference between the first light beam and the second light beam, to alter the splitting ratio of the second coupler.

3. The LiDAR according to claim 1, wherein at least one of the first coupler and the second coupler is any one of an MMI (multimode interference) coupler, a Y-branch coupler or a directional coupler.

4. The LiDAR according to claim 1, wherein at least one of the first coupler and the second coupler is prepared by using material of silicon nitride, silicon, lithium niobate or silicon carbide.

5. The LiDAR according to claim 1, wherein the first coupler is a 1*2 coupler, the second coupler is a 2*2 coupler; at least one of the first coupler and the second coupler is a 3 dB coupler.

6. The LiDAR according to claim 1, wherein the first phase shifter is one of a thermo-optic phase shifter, an electro-optic phase shifter, an acousto-optic phase shifter or an MEMS phase shifter.

7. The LiDAR according to claim 1, wherein the LiDAR comprises an optical chip, the beam splitting structure and the transceiver module are integrated into the optical chip.

8. The LiDAR according to claim 1, wherein the transceiver module comprises an OPA, an optical switch antenna array or an arrayed waveguide grating component.

9. The LiDAR according to claim 1, wherein a range of a splitting ratio of the detection light to the local oscillator light is from (90:10) to (99:1).

10. The LiDAR according to claim 1, wherein a range of a splitting ratio of the detection light to the local oscillator light is from (50:50) to (99.9:0.1).

11. The LiDAR according to claim 1, wherein the LiDAR further comprises a monitoring link;
wherein the local oscillator light is split into two sub-beams, one of the sub-beams is used to beat with the detection light, the other sub-beam serves as correction light and enters the monitoring link to calibrate a ranging result.

12. A control method of a LiDAR, wherein the LiDAR comprises a light source, a beam splitting structure, a transceiver module and a detection module, the beam splitting structure comprises a first coupler, a first phase shifter and a second coupler that are sequentially connected along an optical path; the method comprises following steps:
providing, by the light source, a laser beam to the first coupler in the beam splitting structure;
splitting, by the first coupler, the laser beam into a first light beam and a second light beam, providing the first light beam to the first phase shifter, and providing the second light beam to the second coupler;
altering, by the first phase shifter, a phase of the first light beam, and providing the first light beam with an altered phase to the second coupler;
adjusting, by the second coupler, a splitting ratio according to a phase difference between the first light beam with the altered phase and the second light beam, to form detection light and local oscillator light.

13. The method according to claim 12, wherein the beam splitting structure further comprises a second phase shifter, and the method further comprises a following step:
altering, by the second phase shifter, a phase of the second light beam, to alter the phase difference between the first light beam and the second light beam, to alter the splitting ratio of the second coupler.

14. The method according claim 12, wherein at least one of the first coupler and the second coupler is any one of an MMI (multimode interference) coupler, a Y-branch coupler or a directional coupler.

15. The method according claim 12, wherein at least one of the first coupler and the second coupler is prepared by using material of silicon nitride, silicon, lithium niobate or silicon carbide.

16. The method according claim 12, wherein the first coupler is a 1*2 coupler, the second coupler is a 2*2 coupler; at least one of the first coupler and the second coupler is a 3 dB coupler.

17. The method according claim 12, wherein the transceiver module comprises an OPA, an optical switch antenna array or an arrayed waveguide grating component.

18. The method according claim 12, wherein a range of a splitting ratio of the detection light to the local oscillator light is from (90:10) to (99:1).

19. The method according claim 12, wherein a range of a splitting ratio of the detection light to the local oscillator light is from (50:50) to (99.9:0.1).

20. The method according claim 12, wherein the LiDAR further comprises a monitoring link; the method further comprises:
splitting the local oscillator light into two sub-beams, wherein one of the sub-beams is used to beat with the detection light, the other sub-beam serves as correction light and enters the monitoring link to calibrate a ranging result.
